(19) United States
(12) Patent Application Publication
(10) Pub. No.: US 2013/0275290 A1
(43) Pub. Date: Oct. 17, 2013

(54) SURPLUS ELECTRICITY TRADING SYSTEM, AUCTION SYSTEM, AND SURPLUS ELECTRICITY TRADING METHOD

(71) Applicant: NEC CORPORATION, Tokyo (JP)

(72) Inventor: Koji ARAKAWA, Tokyo (JP)

(73) Assignee: NEC Corporation, Tokyo (JP)

(21) Appl. No.: 13/861,104

(22) Filed: Apr. 11, 2013

(30) Foreign Application Priority Data
Apr. 13, 2012 (JP) 2012-091821

(51) Int. Cl. G06Q 40/04

(52) U.S. Cl. CPC G06Q 40/04
USPC 705/37

(57) ABSTRACT

An auction apparatus is provided including a receiver that receives sales information from a supply system that generates and supplies electricity and receives bidding information from at least one electricity transmission system. The sales information includes a sales period of surplus electricity and a sales volume of the surplus electricity. The apparatus also includes a controller that selects a purchaser from among the at least one electricity transmission system based on the bidding information; a transmitter that transmits the sales information to the electricity transmission system, based on the receipt of the sales information from the supply system and that transmits, to the supply system, an auction result; an electricity receiving unit that receives the surplus electricity from the supply system; and an electricity transmission unit that transmits the surplus electricity to the purchaser.

### BACKGROUND

1. Field of the Invention

Exemplary embodiments relate to a surplus electricity trading system and surplus electricity trading method for trading surplus electricity by auction as well as to an auction system, surplus electricity supply system, auction program, and surplus electricity supply program that are applied to the surplus electricity trading system.

2. Description of the Related Art

Along with deregulation of the electric power industry, it has become possible for electricity users to generate electricity on their own and sell any electricity in excess of their own needs (surplus electricity) to electric utilities. The users who generate electricity on their own and sell surplus electricity to electric utilities will be referred to as surplus electricity marketers. Other than electric utilities, any company (e.g., a company that has a factory, office, or the like) that generates electricity on its own and sells surplus electricity to an electric utility is a surplus electricity marketer.

FIG. 7 is a schematic diagram schematically showing a general electric utility and power producer and supplier that can be a purchaser of surplus electricity. Generally, a surplus electricity marketer 240 supplies surplus electricity to a general electric utility 210 or a power producer and supplier 220 connected to a power distribution grid 230 connected with power equipment of the surplus electricity marketer 240. The surplus electricity marketer 240 has agreed with the general electric utility 210 or power producer and supplier 220 on a selling price of surplus electricity in advance and sells the surplus electricity at that price. Incidentally, the power producer and supplier is sometimes abbreviated to PPS.

Recently, the accuracy of electricity consumption forecasting has improved. Consequently, it has become relatively easy to predict times of peak electricity demand. General electric utilities and power producers and suppliers have become able to estimate electricity deficits expected to occur during the predicted times of peak electricity demand. Also, surplus electricity marketers have become able to estimate amounts of surplus electricity salable during the predicted times of peak electricity demand.

As a surplus electricity trading method, Japanese Patent Laid-Open No. 2011-229234 (Paragraph 0020) describes a method that involves publicly announcing the amount of electricity to be sold as well as the start day and time of sale and determining a purchaser of the electricity based on prices and amounts of electricity indicated by tendering information.

As described above, generally, a surplus electricity marketer 240 supplies surplus electricity to a general electric utility 210 or a power producer and supplier 220 connected to a power distribution grid 230 (see FIG. 7) connected with power equipment of the surplus electricity marketer 240. Thus, even if a purchaser of electricity is determined based on tendering information as with the method described in Japanese Patent Laid-Open No. 2011-229234, possible purchasers are limited to the general electric utility 210 or power producers and suppliers 220 connected to the same power distribution grid as the surplus electricity marketer 240. Therefore, the surplus electricity marketer 240 cannot sell electricity to any electric utility not connected to the same power distribution grid 230 as the surplus electricity marketer 240.

For example, surplus electricity marketers can sell not only the electricity generated by themselves, but also surplus electricity remaining of the electricity generated by themselves and electricity supplied from the electric utility put together.

### SUMMARY OF THE INVENTION

Thus, an object of an exemplary embodiment is to provide a surplus electricity trading system and surplus electricity trading method that allow surplus electricity to be sold even to electric utilities not connected to the same power distribution grid as facilities of a surplus electricity marketer as well as to provide an auction system and auction program that are applied to the surplus electricity trading system.

Another object of an exemplary embodiment is to provide a surplus electricity supply system and surplus electricity supply program that can sell surplus electricity remaining of electricity generated by a surplus electricity marketer and electricity supplied from an electric utility put together.

An exemplary embodiment provides a surplus electricity trading system including: a surplus electricity supply system adapted to generate electricity and supply surplus electricity; and an auction system adapted to conduct communications with an electricity transmission system connected to a same power distribution grid as the surplus electricity supply system as well as with an electricity transmission system not connected to the power distribution grid and determine an electricity transmission system to be designated as a purchaser of the surplus electricity, wherein the surplus electricity supply system includes: an electricity generating unit adapted to generate electricity, a sales information transmission unit adapted to transmit sales information to the auction system, the sales information representing a sales period of electricity and a sales volume of electricity, a determination result receiving unit adapted to receive a determination result on the electricity transmission system designated as a purchaser from the auction system, and a surplus electricity supply system-side electricity transmission unit adapted to transmit the surplus electricity to the auction system in the sales period of electricity if the determination result is received, and the auction system includes: a sales information reporting unit adapted to receive the sales information and transmit the sales information to the electricity transmission system connected to the same power distribution grid as the surplus electricity supply system and the electricity transmission system not connected to the power distribution grid, a bidding information receiving unit adapted to receive bidding information from the electricity transmission system connected to the same power distribution grid as the surplus electricity supply system and the electricity transmission system not connected to the power distribution grid, a purchaser determination unit adapted to determine an electricity transmission system to be designated as a purchaser of the surplus electricity based on the bidding information, a determination result transmission unit adapted to transmit a determination result on the electricity transmission system designated as the purchaser to the surplus electricity supply system, an auction system-side electricity receiving unit adapted to receive the electricity transmitted as the surplus electricity from the surplus electricity supply system-side electricity transmission unit, and an auction system-side electricity transmission unit adapted to transmit the electricity received by the auction system-side electricity receiving unit to the electricity transmission system determined as the purchaser.

Also, an exemplary embodiment provides an auction system including: a sales information reporting unit adapted to receive sales information that represents a sales period of electricity and a sales volume of electricity from a surplus electricity supply system that generates electricity and supplies surplus electricity and transmit the sales information to an electricity transmission system connected to a same power distribution grid as the surplus electricity supply system and an electricity transmission system not connected to the power distribution grid; a bidding information receiving unit adapted to receive bidding information from the electricity transmission system connected to the same power distribution grid as the surplus electricity supply system and the electricity transmission system not connected to the power distribution grid; a purchaser determination unit adapted to determine an electricity transmission system to be designated as a purchaser of the surplus electricity based on the bidding information; a determination result transmission unit adapted to transmit a determination result on the electricity transmission system designated as the purchaser to the surplus electricity supply system; an auction system-side electricity receiving unit adapted to receive the electricity transmitted as the surplus electricity from the surplus electricity supply system; and an auction system-side electricity transmission unit adapted to transmit the electricity received by the auction system-side electricity receiving unit to the electricity transmission system determined as the purchaser.

Also, an exemplary embodiment provides a surplus electricity supply system adapted to generate electricity and supply surplus electricity, including: an electricity generating unit adapted to generate electricity; a surplus electricity supply system-side electricity receiving unit adapted to receive electricity from an electricity transmission system connected to a same power distribution grid as the surplus electricity supply system; an electricity storage unit adapted to store electricity not used by an administrator of the surplus electricity supply system out of the electricity generated by the electricity generating unit and the electricity received by the surplus electricity supply system-side electricity receiving unit; a sales information transmission unit adapted to transmit sales information that represents a sales period of electricity and a sales volume of electricity to an auction system adapted to determine an electricity transmission system to be designated as a purchaser of the surplus electricity based on bidding information received from the electricity transmission system connected to the power distribution grid and an electricity transmission system not connected to the power distribution grid; a determination result receiving unit adapted to receive a determination result on the electricity transmission system designated as the purchaser from the auction system, and a surplus electricity supply system-side electricity transmission unit adapted to transmit the surplus electricity to the auction system in the sales period of electricity if the determination result is received, wherein the surplus electricity supply system-side electricity transmission unit transmits the electricity stored in the electricity storage unit to the auction system as surplus electricity.

Also, an exemplary embodiment provides a surplus electricity trading method whereby a surplus electricity supply system adapted to generate electricity and supply surplus electricity transmits sales information that represents a sales period of electricity and a sales volume of electricity to an auction system adapted to conduct communications with an electricity transmission system connected to a same power distribution grid as the surplus electricity supply system as well as with an electricity transmission system not connected to the power distribution grid and determine an electricity transmission system to be designated as a purchaser of the surplus electricity; the auction system: receives the sales information and transmits the sales information to the electricity transmission system connected to the same power distribution grid as the surplus electricity supply system and the electricity transmission system not connected to the power distribution grid, receives bidding information from the electricity transmission system connected to the same power distribution grid as the surplus electricity supply system and the electricity transmission system not connected to the power distribution grid, determines an electricity transmission system to be designated as a purchaser of the surplus electricity based on the bidding information, and transmits a determination result on the electricity transmission system designated as the purchaser to the surplus electricity supply system; the surplus electricity supply system transmits the surplus electricity to the auction system in the sales period of electricity if the determination result is received; and the auction system: receives the electricity transmitted as the surplus electricity from the surplus electricity supply system, and transmits the electricity received by the auction system to the electricity transmission system determined as the purchaser.

Also, an exemplary embodiment provides an auction program installed on a computer that includes an electricity receiving unit adapted to receive electricity transmitted as surplus electricity from a surplus electricity supply system adapted to generate electricity and supply surplus electricity, and an electricity transmission unit adapted to transmit the electricity to an electricity transmission system designated to be a purchaser, wherein the auction program causes the computer to execute: a sales information reporting process for receiving sales information that represents a sales period of electricity and a sales volume of electricity from the surplus electricity supply system and transmitting the sales information to an electricity transmission system connected to a same power distribution grid as the surplus electricity supply system and an electricity transmission system not connected to the power distribution grid; a bidding information receiving process for receiving bidding information from the electricity transmission system connected to the same power distribution grid as the surplus electricity supply system and the electricity transmission system not connected to the power distribution grid; a purchaser determination process for determining an electricity transmission system to be designated as a purchaser of the surplus electricity based on the bidding information; a determination result transmission process for transmitting a determination result on the electricity transmission system designated as the purchaser to the surplus electricity supply system; and an electricity transmission control process for controlling the electricity transmission unit so as to transmit the electricity received from the surplus electricity supply system to the electricity transmission system designated as the purchaser.

Also, an exemplary embodiment provides a surplus electricity supply program installed on a computer that includes an electricity generating unit adapted to generate electricity, an electricity receiving unit adapted to receive electricity from an electricity transmission system connected to a same power distribution grid as the computer, an electricity storage unit adapted to store electricity not used by an administrator of the computer out of the electricity generated by the electricity generating unit and the electricity received by the electricity receiving unit, and an electricity transmission unit adapted to transmit electricity, wherein the surplus electricity supply program causes the computer to execute: a sales information transmission process for transmitting sales information that represents a sales period of electricity and a sales volume of electricity to an auction system adapted to determine an electricity transmission system to be designated as a purchaser of surplus electricity based on bidding information received from an electricity transmission system connected to the power distribution grid and an electricity transmission system not connected to the power distribution grid; a determination result receiving process for receiving a determination result on the electricity transmission system designated as the purchaser from the auction system, and an electricity transmission control process for controlling the electricity transmission unit so as to transmit the electricity stored in the electricity storage unit to the auction system in the sales period of electricity if the determination result is received.

One or more exemplary embodiments may allow surplus electricity to be sold even to electric utilities not connected to the same power distribution grid as facilities of a surplus electricity marketer.

Also, one or more exemplary embodiments may make it possible to sell surplus electricity remaining of electricity generated by a surplus electricity marketer and electricity supplied from an electric utility put together.

### BRIEF DESCRIPTION OF THE DRAWINGS

FIG. 1 is an explanatory diagram illustrating an example of a surplus electricity trading system according to an exemplary embodiment;

FIG. 2 is a block diagram showing a configuration example of a surplus electricity supply system;

FIG. 3 is a block diagram showing a configuration example of an electricity auction system;

FIG. 4 is a block diagram showing a configuration example of a PPS electricity transmission system.

FIG. 5 is a flowchart showing an exemplary process flow of the surplus electricity trading system according to an exemplary embodiment;

FIG. 6 is a block diagram showing an example of minimum configuration of the surplus electricity trading system according to an exemplary embodiment; and

FIG. 7 is a schematic diagram schematically showing a general electric utility and power producer and supplier that can be a purchaser of surplus electricity.

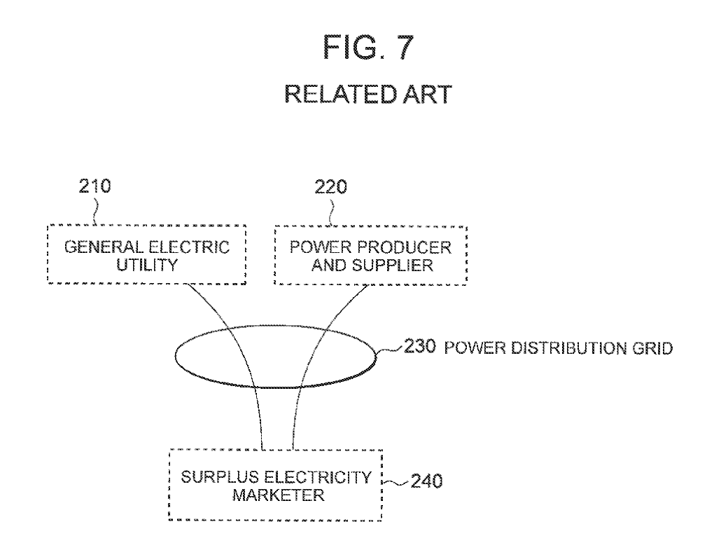

### DETAILED DESCRIPTION

Exemplary embodiments will be described below with reference to the drawings. The word “exemplary” is used herein to mean “serving as an example, instance, or illustration”. Any embodiment described herein as “exemplary” is not necessarily to be construed as preferred or advantageous over other embodiments.

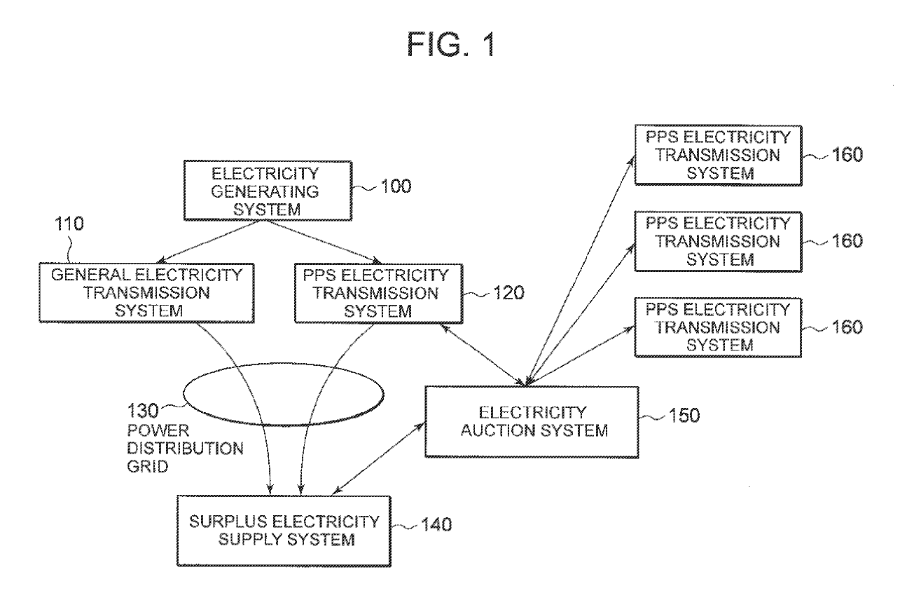

FIG. 1 is an explanatory diagram illustrating an example of a surplus electricity trading system according to an exemplary embodiment. The surplus electricity trading system according to this exemplary embodiment includes a surplus electricity supply system 140 and an electricity auction system 150.

The surplus electricity supply system 140 is managed by a surplus electricity marketer. The surplus electricity supply system 140 is connected to a power distribution grid 130 and supplied with electricity from an electric utility via the power distribution grid 130. Furthermore, the surplus electricity supply system 140 itself has a function to generate electricity. The surplus electricity supply system 140 sells surplus electricity to an electric utility via the electricity auction system 150. Although in the present exemplary embodiment, a purchaser is described as being determined from among power producers and suppliers, general electric utilities may be included in candidate purchasers.

The power distribution grid 130 is connected with an electricity transmission system (hereinafter referred to as a general electricity transmission system) 110 managed by a general electric utility and an electricity transmission system (hereinafter referred to as a PPS electricity transmission system) 120 managed by a power producer and supplier. The surplus electricity supply system 140 may be supplied with electricity from any of the general electricity transmission system 110 and PPS electricity transmission system 120. Incidentally, the general electricity transmission system 110 and PPS electricity transmission system 120 transmit electricity generated by an electricity generating system 100 to electricity consumers. The electricity generating system 100 is managed by an electricity-generating company.

Incidentally, surplus electricity marketers are also electricity consumers.

Also, there are PPS electricity transmission systems 160 not connected to the power distribution grid 130 connected with the surplus electricity supply system 140, but to another power distribution grid (not shown). Although three PPS electricity transmission systems 160 are illustrated in FIG. 1, the number of PPS electricity transmission systems 160 is not limited to three. Individual PPS electricity transmission systems 120 and 160 are managed by respective different power producers and suppliers. The PPS electricity transmission systems 160 transmit electricity to their own respective electricity consumers.

The electricity auction system 150 is connected to each of electricity transmission systems in such a way as to be ready to transmit electricity, where the electricity transmission systems include the PPS electricity transmission system 120 connected to the same power distribution grid 130 as the surplus electricity supply system 140 as well as the PPS electricity transmission systems 160 not connected to the power distribution grid 130. The electricity auction system 150 determines a purchaser of surplus electricity from the surplus electricity supply system 140 by selecting the purchaser from among the PPS electricity transmission systems 120 and 160 by auction. Specifically, the surplus electricity supply system 140 transmits sales information that represents a sales period and sales volume of surplus electricity to the electricity auction system 150, which then transmits the sales information to the PPS electricity transmission systems 120 and 160. Then, the electricity auction system 150 receives bidding information from each of the PPS electricity transmission systems 120 and 160 and determines the purchaser of the surplus electricity based on the received bidding information. When the sales period begins, the surplus electricity supply system 140 transmits the surplus electricity to the electricity auction system 150, which then transmits the surplus electricity to the PPS electricity transmission system determined as the purchaser.

Incidentally, although in FIG. 1, the individual PPS electricity transmission systems 120 and 160 are illustrated as being linked directly to the electricity auction system 150 for ease of explanation, electricity is transmitted from the electricity auction system 150 to the individual PPS electricity transmission systems 120 and 160 via a power distribution grid managed by a general electric utility. The power distribution grid is not necessarily the power distribution grid 130 shown in FIG. 1.

As described above, the electricity auction system 150 is connected to the PPS electricity transmission system 120 and PPS electricity transmission systems 160 in such a way as to be ready to transmit electricity. Thus, the surplus electricity supply system 140 can sell surplus electricity also to the PPS electricity transmission systems 160 not connected to the power distribution grid 130.

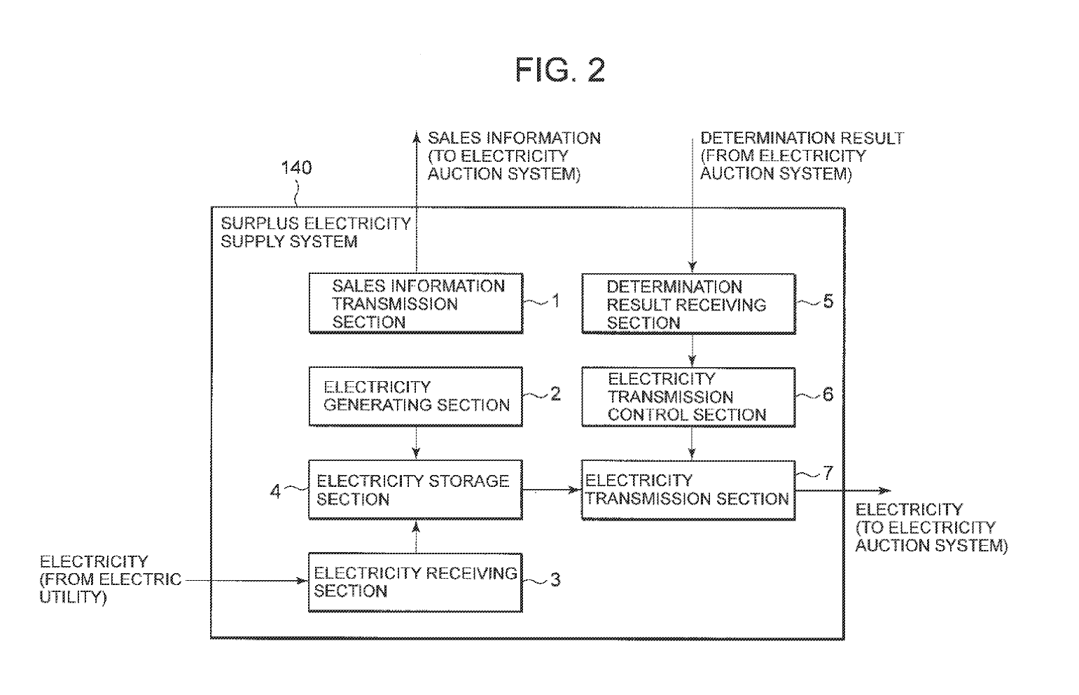

FIG. 2 is a block diagram showing a configuration example of the surplus electricity supply system 140. The surplus electricity supply system 140 includes a sales information transmission section 1, an electricity generating section 2, an electricity receiving section 3, an electricity storage section 4, a determination result receiving section 5, an electricity transmission control section 6, and an electricity transmission section 7.

The sales information transmission section 1 transmits sales information that represents the sales period and sales volume of surplus electricity to the electricity auction system 150 (see FIG. 1). The sales information is inputted to the surplus electricity supply system 140, for example, by a surplus electricity marketer, and the sales information transmission section 1 has only to transmit the sales information. To determine the sales information, for example, a period in which power consumption is expected to peak can be set as the sales period of surplus electricity. Also, an expected amount of surplus electricity during that period can be set as the sales volume of surplus electricity. Incidentally, the sales period and sales volume of the surplus electricity may be determined by another method.

Incidentally, when a surplus electricity marketer enters sales information in the surplus electricity supply system 140, the surplus electricity supply system 140 just has to be equipped with a sales information input device (such as a keyboard; not shown).

The electricity generating section 2 generates electricity. The form in which the electricity generating section 2 generates electricity is not particularly limited. For example, the electricity generating section 2 may generate electricity using solar power. Alternatively, the electricity generating section 2 may generate electricity using a heat pump. The electricity generated by the electricity generating section 2 is used by the surplus electricity marketer.

The electricity receiving section 3 receives electricity from the general electricity transmission system 110 or PPS electricity transmission system 120 via the power distribution grid 130. The electricity received by the electricity receiving section 3 is also used by the surplus electricity marketer.

The electricity storage section 4 stores part of the electricity generated by the electricity generating section 2 that remains unused by the surplus electricity marketer.

Furthermore, the electricity storage section 4 also stores a part of the electricity received by the electricity receiving section 3 that remains unused by the surplus electricity marketer. More electricity than used by the surplus electricity marketer can be received by the electricity receiving section 3, for example, during a predetermined period, such as in the nighttime, when an electricity rate is set low, and the electricity storage section 4 can store unused part of the received electricity. During the other period, the electricity receiving section 3 can receive only as much electricity as needed by the surplus electricity marketer.

The electricity stored in the electricity storage section 4 corresponds to the surplus electricity.

The determination result receiving section 5 receives a determination result on the PPS electricity transmission system designated as a purchaser of the surplus electricity from the auction system 150.

The electricity transmission section 7 transmits electricity stored in the electricity storage section 4 (i.e., surplus electricity) to the auction system 150.

If the determination result on the PPS electricity transmission system designated as the purchaser of the surplus electricity is received, the electricity transmission control section 6 controls the electricity transmission section 7 so as to transmit the surplus electricity to the auction system 150 during the sales period of the surplus electricity specified in the sales information.

The sales information transmission section 1, determination result receiving section 5, and electricity transmission control section 6 are implemented, for example, by a computer that operates according to a surplus electricity supply program. In this case, for example, the computer can read the surplus electricity supply program and then operate as the sales information transmission section 1, determination result receiving section 5, and electricity transmission control section 6 according to the program. Alternatively, the sales information transmission section 1, determination result receiving section 5, and electricity transmission control section 6 may be implemented as separate units.

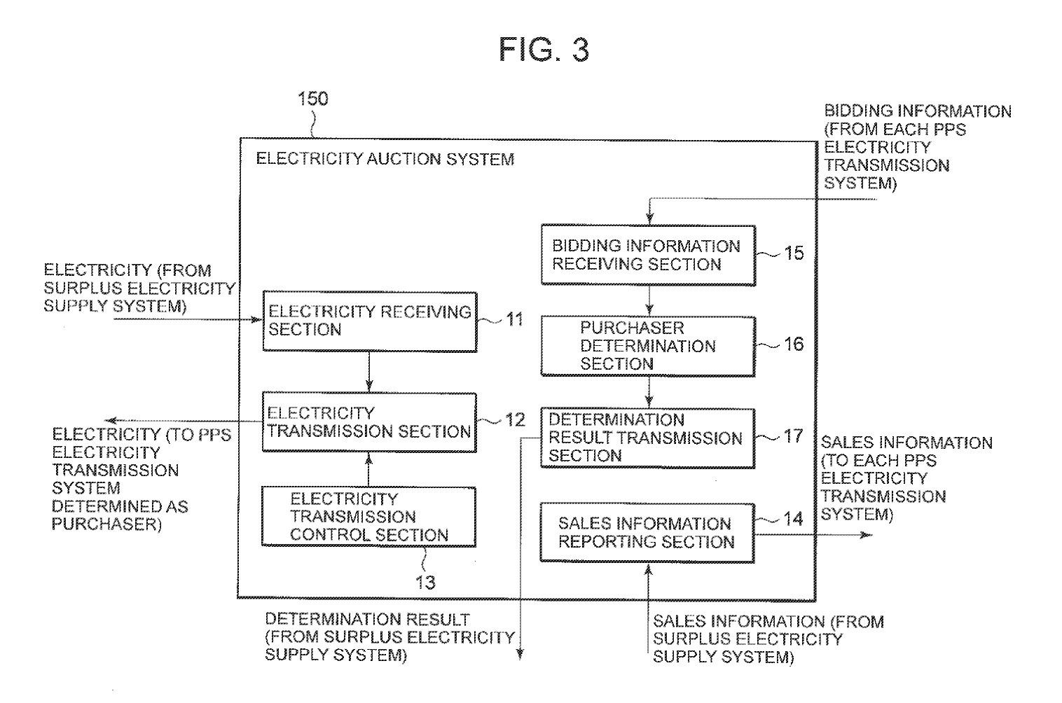

FIG. 3 is a block diagram showing a configuration example of the electricity auction system 150. The electricity auction system 150 includes an electricity receiving section 11, an electricity transmission section 12, an electricity transmission control section 13, a sales information reporting section 14, a bidding information receiving section 15, a purchaser determination section 16, and a determination result transmission section 17.

The sales information reporting section 14 receives the sales information transmitted from the sales information transmission section 1 (see FIG. 2). Then, the sales information reporting section 14 transmits the sales information to each of the PPS electricity transmission system 120 connected to the same power distribution grid 130 as the surplus electricity supply system 140 and PPS electricity transmission systems 160 not connected to the power distribution grid 130.

Incidentally, the form of a communications network that conveys the sales information from the surplus electricity supply system 140 to the electricity auction system 150 is not particularly limited. Similarly, the form of a communications network that conveys sales information between the electricity auction system 150 and PPS electricity transmission systems 120 and 160 is not particularly limited.

The bidding information receiving section 15 receives bidding information transmitted by each of the PPS electricity transmission systems 120 and 160 in response to the sales information. The bidding information contains, for example, information on an electricity purchase volume and purchase price (i.e., bidding price) determined by the power producer and supplier that owns the PPS electricity transmission system as well as identification information on the power producer and supplier.

Incidentally, the form of a communications network that conveys the bidding information from the PPS electricity transmission systems 120 and 160 to the electricity auction system 150 is not particularly limited.

The purchaser determination section 16 determines the purchaser of the surplus electricity for the surplus electricity supply system 140 based on the bidding information received from the PPS electricity transmission systems 120 and 160. For example, the purchaser determination section 16 can determine the purchaser of the surplus electricity by selecting the PPS electricity transmission system that has specified the highest purchase price.

The determination result transmission section 17 transmits a determination result on the PPS electricity transmission system designated as the purchaser of the surplus electricity to the surplus electricity supply system 140. The determination result transmission section 17 transmits information on the determination result together with the information on the electricity purchase volume and purchase price and identification information on the power producer and supplier specified in the bidding information on the PPS electricity transmission system designated as the purchaser.

The form of a communications network that conveys the determination result on the purchaser of the surplus electricity from the electricity auction system 150 to the surplus electricity supply system 140 is not particularly limited.

The electricity receiving section 11 receives the electricity transmitted as surplus electricity from the surplus electricity supply system 140.

Under the control of the electricity transmission control section 13, the electricity transmission section 12 transmits the electricity received by the electricity receiving section 11 to the PPS electricity transmission system determined as the purchaser of surplus electricity.

The electricity transmission control section 13 controls the electricity transmission section 12 so as to transmit the electricity received by the electricity receiving section 11 to the PPS electricity transmission system designated as the purchaser of the surplus electricity.

The sales information reporting section 14, bidding information receiving section 15, purchaser determination section 16, determination result transmission section 17, and electricity transmission control section 13 are implemented, for example, by a computer that operates according to an auction program. In this case, for example, the computer can read the auction program and then operate as the sales information reporting section 14, bidding information receiving section 15, purchaser determination section 16, determination result transmission section 17, and electricity transmission control section 13. Alternatively, the sales information reporting section 14, bidding information receiving section 15, purchaser determination section 16, determination result transmission section 17, and electricity transmission control section 13 may be implemented as separate units.

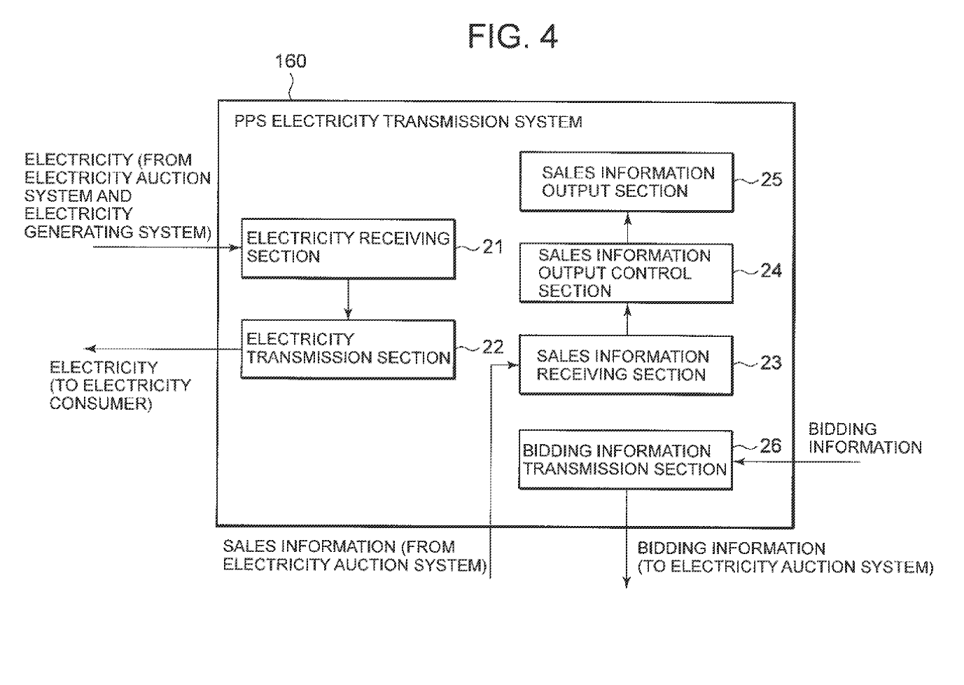

FIG. 4 is a block diagram showing a configuration example of a PPS electricity transmission system. The PPS electricity transmission system 160 not connected to the same power distribution grid 130 as the surplus electricity supply system 140 will be described below as an example with reference to FIG. 4, but a similar configuration also applies to the PPS electricity transmission system 120 connected to the power distribution grid 130.

The PPS electricity transmission system 160 includes an electricity receiving section 21, an electricity transmission section 22, a sales information receiving section 23, a sales information output control section 24, a sales information output section 25, and a bidding information transmission section 26.

The sales information receiving section 23 receives the sales information transmitted from the sales information reporting section 14 (see FIG. 3).

The sales information output section 25 is an output device adapted to output sales information. For example, the sales information output section 25 is a display device that displays the sales information. The form in which the sales information is outputted is not particularly limited, but an example in which the sales information is displayed will be described here.

The sales information output control section 24 causes the sales information output section 25 to output the sales information received by the sales information receiving section 23. In this example, the sales information output control section 24 causes the sales information output section 25 to display the sales information.

The bidding information transmission section 26 transmits the bidding information accepted as input from the power producer and supplier to the electricity auction system 150. At this time, the power producer and supplier can verify the sales information on surplus electricity and then input bidding information including information about the desired electricity purchase volume and purchase price and identification information on the power producer and supplier itself to the PPS electricity transmission system 160. Incidentally, as the electricity purchase volume, the power producer and supplier specifies a volume not larger than the sales volume of surplus electricity indicated in the sales information.

Incidentally, the PPS electricity transmission system 160 is equipped with a bidding information input device (such as a keyboard; not shown), and the bidding information transmission section 26 can transmit the bidding information inputted via the input device, to the electricity auction system 150.

An example in which a power producer and supplier prepares bidding information by verifying sales information will be described here, but the bidding information may be prepared in another form.

The electricity receiving section 21 receives surplus electricity transmitted from the surplus electricity supply system 140 via the electricity auction system 150. Besides, the electricity receiving section 21 also receives electricity from the electricity generating system that supplies electricity to the PPS electricity transmission system 160. Incidentally, although the electricity generating system 100 that supplies electricity to the PPS electricity transmission system 120 is illustrated in FIG. 1, the PPS electricity transmission systems 160 may be supplied with electricity from an electricity generating system other than the electricity generating system 100.

The electricity transmission section 22 transmits electricity to the electricity consumer supplied with electricity from the PPS electricity transmission system 160.

As described above, although in this exemplary embodiment, a purchaser is described as being determined from among power producers and suppliers, general electric utilities may be included in candidate purchasers. In that case, a general electricity transmission system (not shown) not connected to the power distribution grid 130 as well as the general electricity transmission system 110 connected to the power distribution grid 130 can have a configuration similar to that of the PPS electricity transmission systems 120 and 160. The electricity auction system 150 can transmit the sales information not only to PPS electricity transmission systems, but also to general electricity transmission systems, receive bidding information from the general electricity transmission systems as well, and determine a purchaser of the surplus electricity from among the PPS electricity transmission systems and general electricity transmission systems.

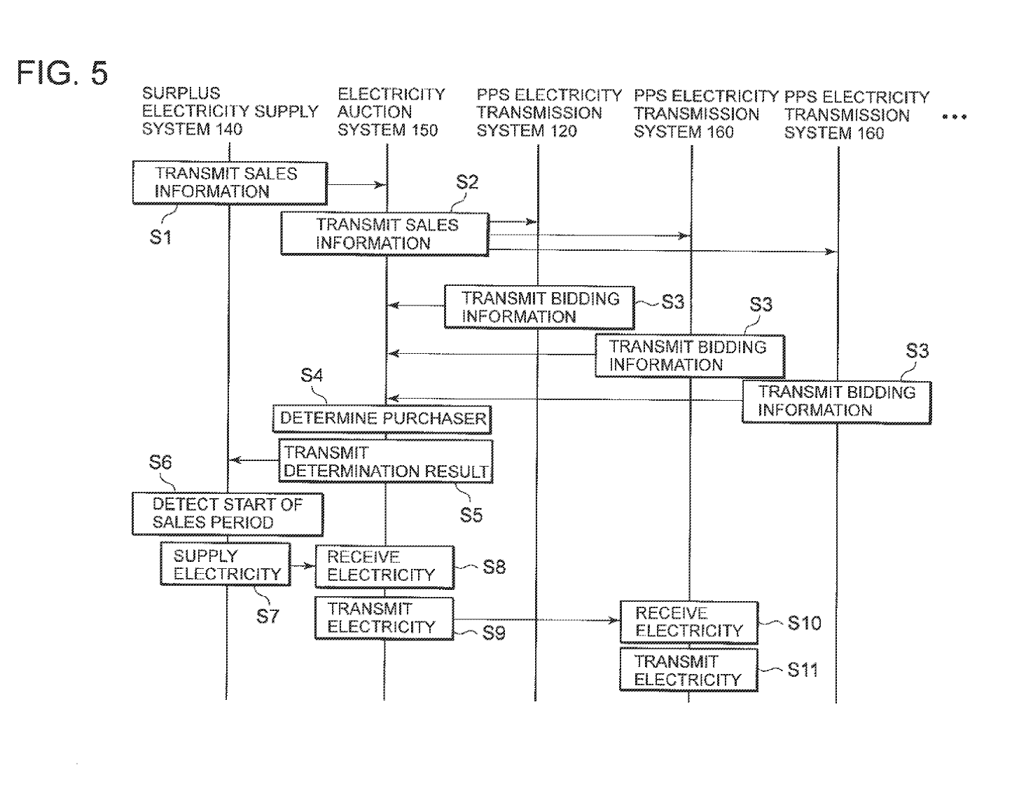

Next, operation of another exemplary embodiment will be described. FIG. 5 is a flowchart showing an exemplary process flow of the surplus electricity trading system according to this exemplary embodiment. When sales information is input in the surplus electricity supply system 140, the sales information transmission section 1 (see FIG. 2) transmits the sales information to the electricity auction system 150 (S1). The sales information represents the sales period and sales volume of surplus electricity.

Upon receiving the sales information, the sales information reporting section 14 (see FIG. 3) of the electricity auction system 150 transmits the sales information to the PPS electricity transmission system 120 connected to the same power distribution grid 130 as the surplus electricity supply system 140 as well as the PPS electricity transmission systems 160 not connected to the power distribution grid 130 (S2).

In each of the PPS electricity transmission systems 120 and 160, the sales information receiving section 23 (see FIG. 4) receives the sales information transmitted in S2 and the sales information output control section 24 causes the sales information output section 25 to display the sales information. The power producer and supplier that is the administrator of each of the PPS electricity transmission systems 120 and 160 verifies the sales period and sales volume of surplus electricity contained in the sales information and determines a desired electricity purchase volume and purchase price. Then, the power producer and supplier inputs bidding information including information about the electricity purchase volume and purchase price and identification information on the power producer and supplier itself to the electricity transmission system managed by the power producer and supplier. Incidentally, other information may be contained further in the bidding information. In each of the PPS electricity transmission systems 120 and 160, the bidding information transmission section 26 transmits the inputted bidding information to the electricity auction system 150 (S3).

When the bidding information receiving section 15 (see FIG. 3) of the electricity auction system 150 receives the bidding information from the electricity transmission systems 120 and 160, the purchaser determination section 16 (see FIG. 3) determines a purchaser of the surplus electricity for the surplus electricity supply system 140 based on the bidding information (S4).

Then, the determination result transmission section (see FIG. 3) puts the information specified in the bidding information on the PPS electricity transmission system in determination result information on the PPS electricity transmission system designated as the purchaser of the surplus electricity, where the information specified in the bidding information includes the information on the electricity purchase volume and purchase price and identification information on the power producer and supplier. Then, the determination result transmission section 17 transmits the determination result information to the surplus electricity supply system 140 (S5). The determination result receiving section 5 (see FIG. 2) of the surplus electricity supply system 140 receives the determination result information.

After S5, upon detecting a start of the sales period specified in the sales information (S6), the electricity transmission control section 6 causes the electricity transmission section 7 to transmit the surplus electricity to the electricity auction system 150. Specifically, the electricity transmission control section 6 causes the electricity transmission section 7 to transmit the electricity stored in the electricity storage section 4 (S7). At this time, out of the electricity generated by the electricity generating section 2 and electricity received by the electricity receiving section 3, the electricity not used by the surplus electricity marketer has been stored in the electricity storage section 4.

In S7, the electricity transmission control section 6 causes the electricity transmission section 7 to transmit electricity, during the sales period, by a volume equal to the electricity purchase volume indicated by the determination result information.

The electricity receiving section 11 (see FIG. 3) of the electricity auction system 150 receives the electricity transmitted in S7 (S8). Then, the electricity transmission control section 13 (see FIG. 3) controls the electricity transmission section 12 so as to transmit the electricity received by the electricity receiving section 11 to the PPS electricity transmission system determined as the purchaser of the surplus electricity in S4. Under the control of the electricity transmission control section 13, the electricity transmission section 12 transmits the electricity to the PPS electricity transmission system designated as the purchaser of the surplus electricity (S9). Consequently, the surplus electricity supplied by the surplus electricity supply system 140 is sent to the PPS electricity transmission system designated as the purchaser, via the electricity auction system 150.

The electricity receiving section 21 (see FIG. 4) of the PPS electricity transmission system determined as the purchaser of surplus electricity receives the electricity transmitted in S9 (S10). Then, the electricity transmission section 22 of the PPS electricity transmission system transmits the electricity to the electricity consumer (S11).

Incidentally, any power producer and supplier that does not wish to purchase the surplus electricity does not need to transmit bidding information to the electricity auction system 150. If bidding information is not received from any PPS electricity transmission system, the purchaser determination section 16 does not need to carry out S4 and S5. If the surplus electricity supply system 140 consequently does not receive determination result information prepared in S4, the electricity transmission control section 6 of the surplus electricity supply system 140 does not need to carry out S7 even if the start of the sales period specified in the sales information is detected. That is, the surplus electricity does not need to be transmitted.

According to an exemplary embodiment, the electricity auction system 150 transmits sales information to each of the PPS electricity transmission system 120 connected to the same power distribution grid 130 as the surplus electricity supply system 140 and PPS electricity transmission systems 160 not connected to the power distribution grid 130 and receives bidding information from the PPS electricity transmission systems 120 and 160. Then, the electricity auction system 150 determines a purchaser of surplus electricity from among the PPS electricity transmission systems based on the bidding information and transmits the determination result to the surplus electricity supply system 140. Then, after receiving the determination result on the purchaser, the surplus electricity supply system 140 transmits the surplus electricity to the electricity auction system 150 during the sales period prescribed in the sales information, and the electricity auction system 150 transmits the electricity to the PPS electricity transmission system determined as the purchaser. Therefore, the surplus electricity marketer can sell surplus electricity not only to the PPS electricity transmission system 120 connected to the same power distribution grid 130 as the surplus electricity supply system 140, but also to the PPS electricity transmission systems 160 not connected to the power distribution grid 130. That is, the surplus electricity marketer can sell the surplus electricity to the purchaser selected based on the bidding information from among the PPS electricity transmission system 120 and PPS electricity transmission systems 160, both of which are regarded as candidate purchasers. This makes it possible to expand a range of prospective purchasers.

Also, according to an exemplary embodiment, the electricity storage section 4 (see FIG. 2) stores part of the electricity generated by the electricity generating section 2 of the surplus electricity supply system 140 that remains unused by the surplus electricity marketer as well as part of the electricity received by the electricity receiving section 3 that remains unused by the surplus electricity marketer. Therefore, unused part of the electricity received by the electricity receiving section 3 can also be sold as surplus electricity. Also, for example, during a predetermined period (such as in the nighttime) when an electricity rate is set low, the surplus electricity marketer can receive more electricity through the electricity receiving section 3 than used by the surplus electricity marketer, store unused part of the received electricity in the electricity storage section 4, and then sell the stored electricity as surplus electricity.

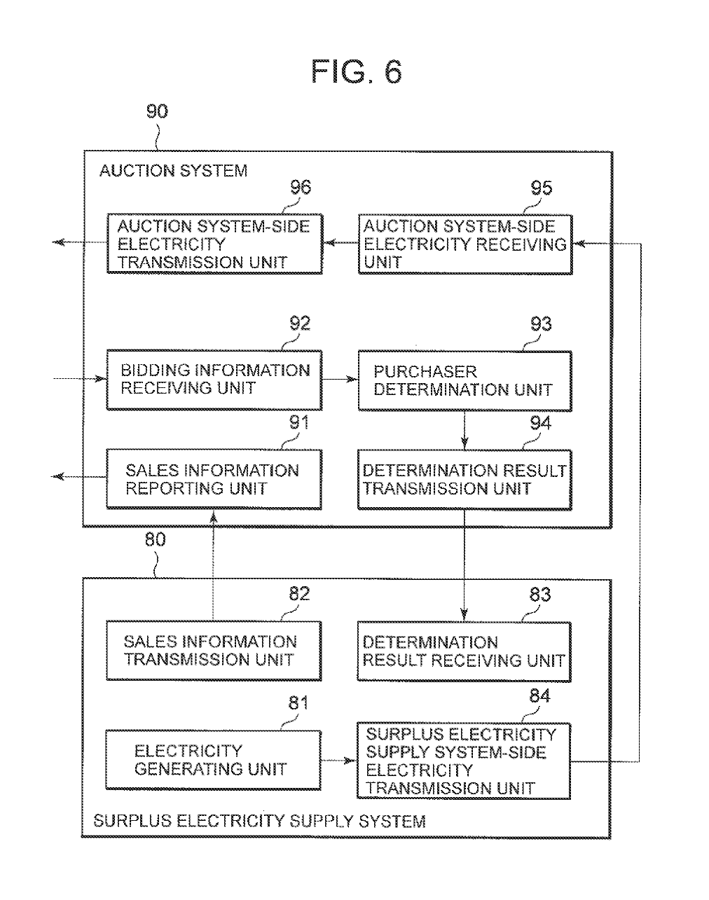

FIG. 6 is a block diagram showing an example of minimum configuration of the surplus electricity trading system according to an exemplary embodiment. The surplus electricity trading system according to the present exemplary embodiment includes a surplus electricity supply system 80 (e.g., the surplus electricity supply system 140) adapted to generate electricity and supply surplus electricity and an auction system 90 (e.g., the electricity auction system 150) adapted to conduct communications with an electricity transmission system (e.g., the PPS electricity transmission system 120) connected to a same power distribution grid as the surplus electricity supply system 80 as well as with an electricity transmission system (e.g., the PPS electricity transmission system 160) not connected to the power distribution grid and determine an electricity transmission system to be designated as a purchaser of the surplus electricity.

The surplus electricity supply system 80 includes an electricity generating unit 81, a sales information transmission unit 82, a determination result receiving unit 83, and a surplus electricity supply system-side electricity transmission unit 84.

The electricity generating unit 81 (e.g., the electricity generating section 2) generates electricity.

The sales information transmission unit 82 (e.g., the sales information transmission section 1) transmits sales information that represents a sales period of electricity and a sales volume of electricity to the auction system 90.

The determination result receiving unit 83 (e.g., the determination result receiving section 5) receives a determination result on the electricity transmission system designated as the purchaser from the auction system 90.

The surplus electricity supply system-side electricity transmission unit 84 (e.g., the electricity transmission section 7) transmits the surplus electricity to the auction system 90 in the sales period of electricity if the determination result is received.

The auction system 90 includes a sales information reporting unit 91, a bidding information receiving unit 92, a purchaser determination unit 93, a determination result transmission unit 94, an auction system-side electricity receiving unit 95, and an auction system-side electricity transmission unit 96.

The sales information reporting unit 91 (e.g., the sales information reporting section 14) receives sales information and transmits the sales information to the electricity transmission system connected to the same power distribution grid as the surplus electricity supply system 80 and the electricity transmission system not connected to the power distribution grid.

The bidding information receiving unit 92 (e.g., the bidding information receiving section 15) receives bidding information from the electricity transmission system connected to the same power distribution grid as the surplus electricity supply system 80 and the electricity transmission system not connected to the power distribution grid.

The purchaser determination unit 93 (e.g., the purchaser determination section 16) determines an electricity transmission system to be designated as a purchaser of the surplus electricity based on the bidding information.

The determination result transmission unit 94 (e.g., the determination result transmission section 17) transmits a determination result on the electricity transmission system designated as the purchaser to the surplus electricity supply system 80.

The auction system-side electricity receiving unit 95 (e.g., electricity receiving section 11) receives the electricity transmitted as surplus electricity from the surplus electricity supply system-side electricity transmission unit 84.

The auction system-side electricity transmission unit 96 (e.g., the electricity transmission section 12) transmits the electricity to the electricity transmission system determined as the purchaser.

This configuration allows surplus electricity to be sold even to electric utilities not connected to the same power distribution grid as facilities of the surplus electricity marketer.

Also, the surplus electricity supply system 80 may further include a surplus electricity supply system-side electricity receiving unit (e.g., the electricity receiving section 3) adapted to receive electricity from the electricity transmission system connected to the same power distribution grid as the surplus electricity supply system 80, and an electricity storage unit (e.g., the electricity storage section 4) adapted to store electricity not used by an administrator of the surplus electricity supply system 80 out of the electricity generated by the electricity generating unit 81 and the electricity received by the surplus electricity supply system-side electricity receiving unit, and the surplus electricity supply system-side electricity transmission unit 84 may transmit the electricity stored in the electricity storage unit to the auction system as surplus electricity.

Thus, one of more exemplary embodiments can be suitably applied to trading of surplus electricity that involves determining a purchaser of the surplus electricity and supplying the electricity to the purchaser.

What is claimed is:

1. An auction apparatus comprising:
a receiver adapted to receive sales information from a supply system that generates and supplies electricity, and to receive bidding information from at least one electricity transmission system, wherein the sales information comprises a sales period of surplus electricity and a sales volume of the surplus electricity;
a controller adapted to determine a purchaser from among the at least one electricity transmission system based on the bidding information;
a transmitter adapted to transmit the sales information to the electricity transmission system, based on the receipt of the sales information from the supply system and to transmit, to the supply system, an auction result,
an electricity receiving unit adapted to receive the surplus electricity from the supply system; and
an electricity transmission unit adapted to transmit the surplus electricity to the purchaser.

2. The auction apparatus according to claim 1, wherein the bidding information comprises:
a volume of electricity to be purchased;
a purchase price; and
identification information identifying the electricity transmission system.

3. The auction apparatus according to claim 1, wherein the auction result comprises:
a volume of electricity to be purchased,
a purchase price; and
identification information identifying the purchaser.

4. A electricity supply system comprising:
a surplus electricity supply system;
an electricity auction system; and
at least one electricity transmission system which is not connected to the surplus electricity supply system via any power distribution grid;
wherein the surplus electricity supply system comprises:
a transmitter which transmits sales information to the electricity auction system, the sales information comprising a sales period of surplus electricity and a sales volume of the surplus electricity; and
a electricity transmission unit which, based on an auction result, transmits the surplus electricity to the auction system;
wherein the electricity auction system comprises:
a transmitter which, in response to the electricity auction system receiving the sales information, transmits the sales information to the at least one electricity transmission system;
a receiver which receives bidding information from the at least one electricity transmission system;
a controller which determines a purchaser from among the at least one electricity transmission system based on the bidding information;
an electricity receiving unit which receives the surplus electricity from the supply system; and
an electricity transmission unit which transmits the surplus electricity to the purchaser.

5. A method of an electricity auction system selling surplus electricity, the method comprising:
receiving sales information from a supply system, the sales information comprising a sales period of surplus electricity and a sales volume of the surplus electricity;
transmitting, to at least one electricity transmission system which is not connected to the supply system via any power distribution grid, the sales information;
receiving bidding information from the at least one electricity transmission system, the bidding information;
selecting a purchaser of the surplus electricity from among the at least one electricity transmission system based on the bidding information;
transmitting an auction result to the supply system;
receiving the surplus electricity from the supply system; and
transmitting the surplus electricity to the purchaser.

6. The method according to claim 5, wherein the bidding information comprises:
a volume of electricity to be purchased;
a purchase price; and
identification information identifying the electricity transmission system.

7. The method according to claim 5, wherein the auction result comprises:
a volume of electricity to be purchased,
a purchase price; and
identification information identifying the purchaser.

8. A non-transitory computer readable medium embodying instructions for a method of an auction system selling surplus electricity, the method comprising:
receiving sales information from a supply system, the sales information comprising a sales period of surplus electricity and a sales volume of surplus electricity;
transmitting, to at least one electricity transmission system which is not connected to the supply system via any power distribution grid, the sales information;
receiving bidding information from the at least one electricity transmission system, the bidding information;
selecting a purchaser of the surplus electricity from among the at least one electricity transmission system based on the bidding information;
transmitting an auction result to the supply system;
receiving the surplus electricity from the supply system; and
transmitting the surplus electricity to the purchaser.
